(19) United States
(12) Patent Application Publication
(10) Pub. No.: US 2022/0193925 A1
(43) Pub. Date: Jun. 23, 2022

(54) Tool Changing System, Industrial Robot And Method Of Handling Tool By Industrial Robot

(71) Applicant: ABB Schweiz AG, Baden (CH)

(72) Inventors: Mohammadali Honarpardaz, Västerås (SE); Sead Travancic, Kolbäck (SE)

(21) Appl. No.: 17/594,713

(22) PCT Filed: May 15, 2019
(86) PCT No.: PCT/EP2019/062409

§ 371 Date: Oct. 27, 2021

(51) Int. Cl. B25J 15/02; B25J 15/04

(52) U.S. Cl. CPC B25J 15/0253; B25J 15/0491; B25J 15/0475; B25J 15/0441

(57) ABSTRACT

A tool changing system for an industrial robot, the tool changing system including a tool; a base member for arrangement in a manipulator of the industrial robot and for holding the tool; and a tool storage for holding the tool when released from the base member; and a base member force device configured to force the tool to the base member in any orientation of the base member when the tool is held by the base member; and a tool storage force device configured to force the tool to the tool storage in any orientation of the tool storage when the tool is held by the tool storage. A method of handling a tool by an industrial robot is also provided.

### TECHNICAL FIELD

The present disclosure generally relates to tool changing systems. In particular, a tool changing system for an industrial robot, an industrial robot comprising a tool changing system, and a method of handling a tool by an industrial robot, are provided.

### BACKGROUND

Some known industrial robots comprise one or more end effectors having one or more tools for manipulating a workpiece. The end effector may for example comprise two gripper fingers for gripping a workpiece. Many industrial implementations require the robot to handle a wide range of types of workpieces, e.g. having different shapes, different sizes, different structural strengths and/or different surface properties. Thus, differently shaped gripper fingers may be required for manipulating different types of workpieces.

The task of replacing the gripper fingers is often difficult and time consuming. In order to change a tool, the robot may comprise various multi-object grasping systems. Such grasping systems typically comprise either a replaceable end effector, or a multi-functional end effector. Replacing the entire end effector is time-consuming and expensive since several equipped end effectors need to be provided. Multi-functional end effectors, e.g. comprising a plurality of end effectors on a rotatable device, are heavy and thereby reduce the robot's payload capacity and functionality.

DE 3705884 A1 discloses a gripper system for industrial robots. The gripper system comprises movable gripper fingers to which there can be attached a plurality of gripper jaws which are placed in readiness in a magazine. The gripper jaws can be inserted into, or removed from, the respective magazine places by a linear movement of the gripper system from or in a direction which is perpendicular to the direction of movement of the gripper fingers.

### SUMMARY

One object of the present disclosure is to provide a tool changing system for an industrial robot, which tool changing system has a flexible design.

A further object of the present disclosure is to provide a tool changing system for an industrial robot, which tool changing system enables a compact storage of one or more tools.

A still further object of the present disclosure is to provide a tool changing system for an industrial robot, which tool changing system enables a simple, fast and/or reliable changing of one or more tools used by the industrial robot.

A still further object of the present disclosure is to provide a tool changing system for an industrial robot, which tool changing system is cheap.

A still further object of the present disclosure is to provide a tool changing system for an industrial robot, which tool changing system has a simple design.

A still further object of the present disclosure is to provide a tool changing system for an industrial robot, which tool changing system solves several or all of the foregoing objects in combination.

A still further object of the present disclosure is to provide an industrial robot comprising a tool changing system, which industrial robot solves one, several or all of the foregoing objects.

A still further object of the present disclosure is to provide a method of handing a tool by an industrial robot, which method solves one, several or all of the foregoing objects.

According to one aspect, there is provided a tool changing system for an industrial robot, the tool changing system comprising a tool; a base member for arrangement in a manipulator of the industrial robot and for holding the tool; and a tool storage for holding the tool when released from the base member; and a base member force device configured to force the tool to the base member in any orientation of the base member when the tool is held by the base member; and a tool storage force device configured to force the tool to the tool storage in any orientation of the tool storage when the tool is held by the tool storage.

By means of the base member force device, the base member can be moved in any direction and in any orientation in space while the tool is held stably by the base member. By means of the tool storage force device, one or more tools can be held by the tool storage in any orientation of the tool storage. This improves the flexibility of the industrial robot.

The base member force device may be arranged on the base member, on the tool, or on both the base member and the tool. The tool storage force device may be arranged on the tool storage, on the tool, or on both the tool storage and the tool. In case the tool storage is facing downwards, the tool storage force device can generate a vertically upwardly directed force on the tool against the tool storage. The tool storage force device can generate a holding force on the tool against the tool storage that overcomes the gravity force acting on the tool. Thereby, one or more tools may hang from below the tool storage by means of the tool storage force device.

The tool storage may be configured to be connected to a stationary structure. The tool storage may be formed in one unit.

The base member is configured to form part of the manipulator. The base member may for example be constituted by a finger mounting plate of the manipulator, or may be attached to such finger mounting plate. The tool changing system thereby enables retrofitting of the tool changing system to an existing industrial robot. The base member may have a major dimension in a plane perpendicular to the base member direction.

The tool changing system may comprise one or several tool storages. In any case, each tool storage may comprise one or more storage positions, where one tool can be held by the tool storage at each storage position. Each tool storage may for example comprise four storage positions for holding up to four tools. The storage positions may alternatively be referred to as stations. The tool changing system enables replacement of only a tool of the manipulator, instead of an entire end effector or hand of the manipulator.

The base member force device and the tool storage force device may function purely mechanically, i.e. without the need of any electronics. The tool changing system may comprise a plurality of tools.

The base member force device may comprise a permanent magnet. The permanent magnet of the base member force device may be arranged to generate an attracting magnetic force between the tool and the base member when the base member is positioned in proximity to the tool. Thereby, the need for electric wiring through the manipulator to one or more base members can be avoided. Permanent magnets provide a reliable operation and are relatively cheap.

The permanent magnet of the base member force device may be arranged either on the base member or on the tool. For example, the base member force device may comprise a permanent magnet arranged on the base member and a material strongly responsive to magnetic fields arranged on the tool, or vice versa. Alternatively, the base member force device may comprise two attracting permanent magnets: one permanent magnet arranged on each of the base member and the tool.

The tool storage force device may comprise a magnet, such as a permanent magnet. The magnet of the tool storage force device may be arranged to generate an attracting magnetic force between the tool storage and the tool when the tool is positioned in proximity to the tool storage.

The magnet of the tool storage force device may be arranged either on the tool storage or on the tool. For example, the tool storage force device may comprise a permanent magnet arranged on the tool storage and a material strongly responsive to magnetic fields arranged on the tool, or vice versa. Alternatively, the tool storage force device may comprise two attracting permanent magnets: one permanent magnet arranged on each of the tool storage and the tool. As a further alternative, the tool storage force device may comprise an electromagnet arranged on the tool storage and a material strongly responsive to magnetic fields arranged on the tool.

The tool changing system may further comprise a manipulator having a distal link member, such as a hand. In this case, the base member may be arranged in the manipulator and the base member may be configured to move linearly along an actuation line relative to the distal link member. Throughout the present disclosure, a movement of the base member along the actuation line relative to the distal link member of the manipulator may be referred to as an actuation movement.

The manipulator may comprise two base members according to the present disclosure. In this case, each base member may be movable linearly along a respective actuation line, e.g. along two parallel and offset actuation lines, or along the same actuation line. The two base members of the manipulator may be a gripping mechanism.

The tool changing system may further comprise an industrial robot comprising the manipulator. The industrial robot may comprise one, two, or more than two manipulators. Each manipulator may be programmable in three or more axes and may comprise a distal link member.

The base member force device may be configured to force the tool to the base member in a base member direction substantially perpendicular to, or perpendicular to, the actuation line when the tool is held by the base member. When the tool is held by the base member and the base member is moved along the actuation line, the movement of the base member does not counteract the forcing of the tool to the base member by means of the base member force device.

This variant provides a simple way to attach the tool to the base member, and detach the tool from the base member, without having to move the base member relative to the distal link member along the actuation line. Furthermore, in case the tool changing system comprises a manipulator having two base members in a gripping mechanism and a tool connected to each base member, a first tool can be detached from the first base member while the second tool remains held by the second base member and without having to move any of the base members relative to the distal link member along the actuation line. In other words, this variant enables replacement of only one of two tools by only moving the manipulator, and without having to perform an actuating movement of any of the base members.

The tool storage force device may be configured to force the tool to the tool storage in a tool storage direction substantially parallel to, or parallel to, the actuation line when the tool is held by the tool storage and by the base member. For example, in case the tool changing system comprises two base members in a gripping mechanism, this variant enables one of two tools held by the base members to be replaced in a simple way.

Regardless of whether or not the base member is configured to move linearly along the actuation line, the base member force device may be configured to force the tool to the base member in the base member direction, and the tool storage force device may be configured to force the tool to the tool storage in the tool storage direction, substantially perpendicular to, or perpendicular to, the base member direction, when the tool is held by the tool storage and by the base member. Thereby, in order to detach the tool from the base member and attach the tool to the tool storage, the base member first performs a movement (by means of the manipulator) towards the tool storage in the tool storage direction to attach the tool to the tool storage, and then performs a movement away from the tool in the base member direction to detach the tool from the base member. Conversely, in order to attach the tool to the base member, the base member first performs a movement towards the tool parallel with the base member direction to attach the tool to the base member, and then performs a movement away from the tool storage parallel with the tool storage direction to detach the tool from the tool storage. Thus, the tool changing system enables the manipulator to leave a tool at the tool storage by only two movements of the base member, and to pick up a tool from the tool storage by only two movements of the base member.

The tool storage may comprise a plurality of storage positions arranged along a storage position line. In this case, the storage position line may be substantially perpendicular to, or perpendicular to, each of the base member direction and the tool storage direction when the tool is held by the base member and by the tool storage. This enables a compact design of the tool storage.

The tool may comprise a connection part having a connection part base surface. In this case, the base member may comprise a base member holding surface, and the base member force device may be configured to force the connection part base surface matingly against the base member holding surface when the tool is held by the base member. The connection part base surface may have a shape and size substantially corresponding to, or corresponding to, the base member holding surface. Each of the connection part base surface and the base member holding surface may be flat. The connection part base surface is a surface on the connection part arranged to be brought into contact with the base member. The base member holding surface is a surface on the base member arranged to be brought into contact with the tool.

The tool may comprise a connection part having a connection part storage surface. In this case, the tool storage may comprise a tool storage holding surface, the tool storage force device may be configured to force the connection part storage surface matingly against the tool storage holding surface when the tool is held by the tool storage, and the connection part storage surface may be wider than the tool storage holding surface. Each of the connection part storage surface and the tool storage holding surface may be flat. The connection part storage surface is a surface on the connection part arranged to be brought into contact with the tool storage. The tool storage holding surface is a surface on the tool storage arranged to be brought into contact with the tool.

The tool changing system may further comprise a base member positioning arrangement configured to unambiguously define a relative position between the tool and the base member when the tool is held by the base member. The base member positioning arrangement may comprise one or more pairs of a positioning pin and a corresponding hole.

The tool changing system may further comprise a tool storage positioning arrangement configured to unambiguously define a relative position between the tool and the tool storage when the tool is held by the tool storage. The tool storage positioning arrangement may comprise one or more pairs of positioning pins and holes.

The tool storage may comprise a flat body having a main extension plane. In this case, the body may comprise a tool storage holding surface substantially perpendicular to, or perpendicular to, the main extension plane of the body, and the tool may comprise a connection part having a connection part storage surface for mating with the tool storage holding surface when the tool is held by the tool storage. The flat body enables a compact storage of one or more tools, in particular tools comprising a gripper finger inclined with respect to the connection part.

Furthermore, the flat body of the tool storage enables the tool storage to hold a tool in two opposite orientations in the same storage position. For example, in case the flat body is oriented horizontally, a tool comprising a connection part and a gripper finger extending from the connection part can be held in the storage position with the gripper finger pointing upwards, or with the gripper finger pointing downwards. This enables a compact stacking of several tools in the tool storage, for example tools comprising gripper fingers extending at an angle (e.g. 45°) from the connection part substantially parallel with the tool storage holding surface.

Furthermore, in case one or more of the tools comprise a connection part and a gripper finger extending from the connection part at an angle (e.g. 45°), the flat body of the tool storage enables the tool storage to hold one or more such tools in a way where the gripper finger extends over or under the flat body, i.e. beyond the tool storage holding surface.

The tool may comprise a connection part and a gripper finger for manipulating a workpiece. In this case, the gripper finger may extend from the connection part, the base member force device may be configured to force the connection part against the base member when the tool is held by the base member, and the tool storage force device may be configured to force the connection part against the tool storage when the tool is held by the tool storage.

The tool changing system may comprise two base members and two tools. In this case, each tool may comprise a gripper finger and the gripper fingers may be arranged to grip a workpiece when the tools are connected to the base members.

According to a further aspect, there is provided an industrial robot comprising a tool changing system according to the present disclosure. The industrial robot may be a collaborative robot. The tool storage may be attached to a base of the industrial robot, or to a work table.

According to a further aspect, there is provided a method of handling a tool by an industrial robot, the industrial robot comprising a manipulator having a base member for holding a tool, a tool storage for holding the tool when released from the base member, a base member force device configured to force the tool to the base member in any orientation of the base member when the tool is held by the base member, and a tool storage force device configured to force the tool to the tool storage in any orientation of the tool storage when the tool is held by the tool storage, the method comprising holding the tool to the base member by means of the base member force device; moving the tool to the tool storage by means of the manipulator such that the tool is additionally held by the tool storage by means of the tool storage force device, and such that the base member force device exerts a force on the tool in a base member direction and the tool storage force device exerts a force on the tool in a tool storage direction substantially perpendicular to the base member direction; and moving the base member by means of the manipulator substantially perpendicular to the tool storage direction such that the tool is released from the base member and maintained held by the tool storage. In this way, the industrial robot can automatically hand over a tool from the base member to the tool storage in a simple and reliable manner. The method may be carried out by an industrial robot comprising a tool changing system of any type according to the present disclosure.

The method may further comprise holding the tool to the tool storage by means of the tool storage force device; moving the base member to the tool storage by means of the manipulator such that the tool is additionally held by the base member by means of the base member force device; moving the base member by means of the manipulator in the tool storage direction such that the tool is released from the tool storage and maintained held by the base member. In this way, the industrial robot can automatically pick up a tool from the tool storage in a simple and reliable manner.

### BRIEF DESCRIPTION OF THE DRAWINGS

Further details, advantages and aspects of the present disclosure will become apparent from the following embodiments taken in conjunction with the drawings, wherein:

FIG. 1: schematically represents a front view of an industrial robot comprising a tool changing system;

FIG. 2: schematically represents a perspective view of a base member of the tool changing system;

FIG. 3: schematically represents perspective view of a tool of the tool changing system;

FIG. 4: schematically represents a perspective view of a tool storage of the tool changing system; and

FIG. 5: schematically represents a perspective view of the tool changing system.

### DETAILED DESCRIPTION

In the following, a tool changing system for an industrial robot, an industrial robot comprising a tool changing system, and a method of handling a tool by an industrial robot, will be described. The same reference numerals will be used to denote the same or similar structural features.

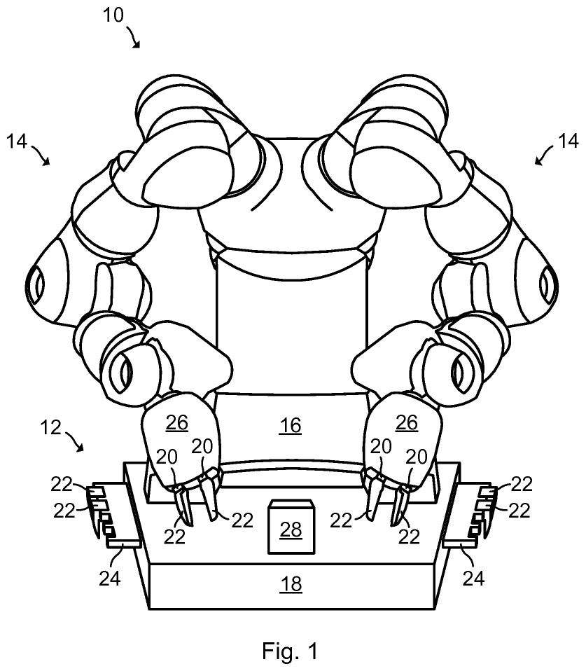

FIG. 1 schematically represents a front view of an industrial robot 10 comprising a tool changing system 12. The industrial robot 10 of this example is constituted by a dual arm collaborative robot comprising two manipulators 14 with similar or identic configuration and a base 16. The industrial robot 10 is positioned on a work table 18. Each manipulator 14 comprises a plurality of joints and is thereby movable about a plurality of axes. In the example of FIG. 1, each manipulator 14 comprises seven joints and has seven degrees of freedom.

The industrial robot 10 of this example is a truly collaborative robot, i.e. a collaborative robot that is constructed to not be capable of injuring humans. The industrial robot 10 may have a mass of 100 kg or less. Alternatively, or in addition, the industrial robot 10 may comprise one or more arms driven at a power that is less than 80 W. A truly collaborative robot differs from an originally non-collaborative industrial robot that is retrofitted with sensor to be made collaborative. One example of a truly collaborative robot is the YuMi® by ABB. Although the industrial robot 10 in FIG. 1 is a collaborative robot, the present disclosure is not limited to robots of this type.

The tool changing system 12 of this example comprises the two manipulators 14, a plurality of base members 20, a plurality of tools 22 and two tool storages 24. Each manipulator 14 comprises a distal link member, here in the form of a hand 26. A gripping mechanism comprising two base members 20 is provided at each hand 26. Each base member 20 is designed for permanent installation in the hand 26 of a respective manipulator 14, in this example by fastening the base member 20 to an associated finger mounting plate (not shown) by means of one or more screws through screw holes in the base member 20 (not shown).

As shown in FIG. 1, each base member 20 holds one tool 22. Each base member 20 is movable relative to the hand 26 along an actuation line (not denoted). By moving the base members 20 towards each other along the actuation line, each hand 26 can grip a workpiece 28 by means of the tools 22.

Furthermore, each tool storage 24 in FIG. 1 holds two tools 22. Each tool storage 24 comprises a plurality of storage positions (four in this example). In FIG. 1, each tool storage 24 faces horizontally (to the left and to the right, respectively, in FIG. 1). The tools 22 are oriented generally vertically in the respective tool storage 24 on the sides of the work table 18 while a workpiece 28 on the work table 18 can be manipulated by the tools 22 of the hands 26. Thereby, the tool changing system 12 enables a compact workspace and/or an efficient utilization of the workspace of the industrial robot 10.

By means of a tool storage force device (not shown), each tool storage 24 may be oriented arbitrarily in space. One or more tool storages 24 may for example face downwards such that one or more tools 22 held by the tool storage 24 are below the tool storage 24. In FIG. 1, each tool storage 24 is configured as a unit attached to the work table 18. One or more tool storages 24 may however be attached to the base 16 or to other parts in the workspace of the industrial robot 10. Each tool storage 24 may be integrally formed, e.g. by means of additive manufacturing.

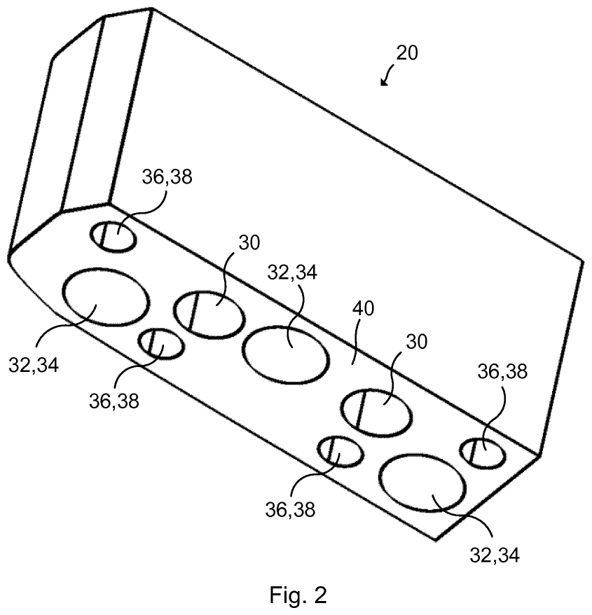

FIG. 2 schematically represents a perspective view of one of the base members 20 of the tool changing system 12 in FIG. 1. In FIG. 2, the screw holes 30, for connection of the base member 20 to the hand 26 by means of screws, can be seen.

The base member 20 of this example comprises three permanent magnets 32. The permanent magnets 32 form part of one example of a base member force device 34 for forcing the tool 22 towards the base member 20 in any orientation of the base member 20 when the tool 22 is held by the base member 20.

The base member 20 of this example further comprises four positioning openings 36. The positioning openings 36 form part of one example of a base member positioning arrangement 38.

Except for the positioning openings 36, the screw holes 30 and possible recesses for accommodating the permanent magnets 32, the base member 20 is of a solid structure. FIG. 2 further shows a flat base member holding surface 40 of the base member 20. The permanent magnets 32 are arranged in the base member holding surface 40.

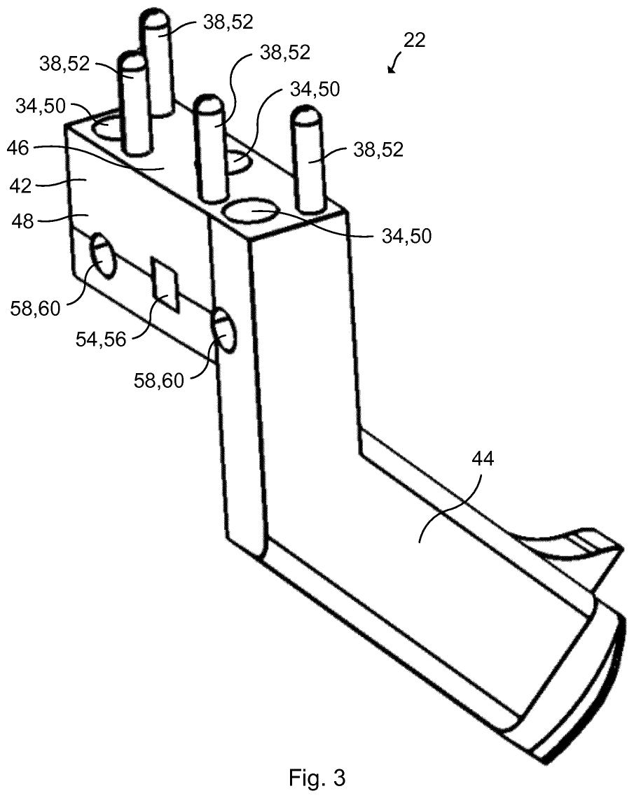

FIG. 3 schematically represents perspective view of one of the tools 22 of the tool changing system 12 in FIG. 1. The tool 22 of the example in FIG. 3 comprises a connection part 42 and a gripper finger 44 extending from the connection part 42. In FIG. 3, the gripper finger 44 extends partly at an angle of 45° relative to the connection part 42.

The connection part 42 comprises a flat connection part base surface 46 and a flat connection part storage surface 48. The connection part storage surface 48 is perpendicular to the connection part base surface 46.

The tool 22 of this example comprises three permanent magnets 50 arranged on the connection part base surface 46. The permanent magnets 50 of the tool 22 and the permanent magnets 32 of the base member 20 magnetically attract each other when the tool 22 is in proximity to the base member 20. The permanent magnets 50 of the tool 22 together with the permanent magnets 32 of the base member 20 form one example of a base member force device 34 configured to force the tool 22 to the base member 20 in any orientation of the base member 20 when the tool 22 is held by the base member 20.

The tool 22 of this example further comprises four positioning pins 52. The positioning pins 52 protrude from the connection part base surface 46. The positioning pins 52 of the tool 22 and the positioning openings 36 of the base member 20 form one example of a base member positioning arrangement 38 configured to unambiguously define a relative position between the tool 22 and the base member 20 when the tool 22 is held by the base member 20. The positioning pins 52 of the tool 22 and the corresponding positioning openings 36 of the base member 20 enable alignment of the tool 22 with the base member 20.

When the tool 22 is held by the base member 20, the connection part base surface 46 mates with the base member holding surface 40. The connection part base surface 46 has the same shape and size as the base member holding surface 40.

By means of the positioning pins 52 and the permanent magnets 32, 50, the tool 22 can easily be positioned relative to the base member 20 in an unambiguously defined relative position. The base member positioning arrangement 38 in combination with the permanent magnets 32, 50 provide an alignment effect when the base member 20 approaches the tool 22. Thereby, the requirements on the movement accuracy of the base member 20 when approaching the tool 22 are reduced. As shown in FIG. 3, each positioning pin 52 has a tapered tip (rounded in FIG. 3) that further facilitates the relative positioning between the tool 22 and the base member 20.

The positioning pins 52 also eliminate the play between the tool 22 and the base member 20. The tool 22 can be reliably held to the base member 20 by means of the permanent magnets 32, 50. In this way, detachment of the tool 22 from the base member 20 is prevented when carrying out a handling operation on the workpiece 28.

In the example in FIG. 3, the connection part 42 of the tool 22 comprises a permanent magnet 54 arranged on the connection part storage surface 48. The permanent magnet 54 forms part of one example of a tool storage force device 56 for forcing the tool 22 towards the tool storage 24.

Furthermore, in the example in FIG. 3, the connection part 42 of the tool 22 comprises two positioning openings 58 arranged in the connection part storage surface 48. The positioning openings 58 form part of one example of a tool storage positioning arrangement 60.

Except for the positioning openings 58 and possible recesses for accommodating the permanent magnets 50, 54 and parts of the positioning pins 52, the tool 22, including the connection part 42 and the gripper finger 44, is of a solid structure. The tool 22 may for example be produced by means of additive manufacturing, such as by 3D printing.

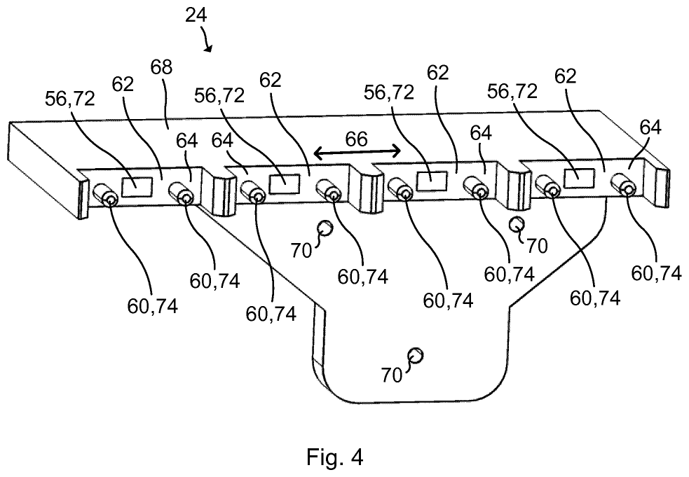

FIG. 4 schematically represents a perspective view of one of the tool storages 24 of the tool changing system 12 in FIG. 1. In FIG. 4, the storage positions 62 of the tool storage 24 are also denoted. The tool storage 24 is configured to hold a tool 22, released from the base member 20, in one, several or each of the storage positions 62.

The tool storage 24 comprises a plurality of flat tool storage holding surfaces 64, one in each storage position 62. The tool storage holding surfaces 64 of this example are aligned in the same plane. Moreover, the storage positions 62 are arranged side by side along a storage position line 66.

The tool storage 24 comprises a flat body 68 having a main extension plane, perpendicular to the tool storage holding surfaces 64. The tool storage 24 further comprises screw holes 70 for receiving screws (not shown) for attachment of the tool storage 24 to a stationary structure, e.g. to the base 16 of the industrial robot 10 or the work table 18.

The tool storage 24 of this example comprises a plurality of permanent magnets 72. One permanent magnet 72 is arranged on a respective tool storage holding surface 64. The permanent magnet 54 of the tool 22 and the permanent magnet 72 in one storage position 62 of the tool storage 24 magnetically attract each other when the tool 22 is in proximity to the storage position 62. The permanent magnet 54 of the tool 22 together with a permanent magnet 72 of the tool storage 24 form one example of a tool storage force device 56 configured to force the tool 22 to the tool storage 24 in any orientation of the tool storage 24 when the tool 22 is held by the tool storage 24.

The tool storage 24 of this example further comprises a plurality of positioning pins 74. Two positioning pins 74 protrude from each tool storage holding surface 64. The positioning pins 74 of the tool storage 24 and the positioning openings 58 of the tool 22 form one example of a tool storage positioning arrangement 60 configured to unambiguously define a relative position between the tool 22 and the tool storage 24 when the tool 22 is held by the tool storage 24. The positioning openings 58 of the tool 22 guide the tool 22 to the tool storage 24. The permanent magnets 54, 72 are configured to hold the tool 22 reliably in a storage position 62.

By means of the positioning pins 74 and the permanent magnets 54, 72, the tool 22 can easily be positioned relative to the tool storage 24 in an unambiguously defined relative position in one of the storage positions 62. The tool storage positioning arrangement 60 in combination with the permanent magnet 54, 72 provide an alignment effect when the tool 22 approaches the tool storage 24. Thereby, the requirements on the movement accuracy of the tool 22 when approaching the tool storage 24 are reduced. As shown in FIG. 4, each positioning pin 74 has a tapered tip (rounded in FIG. 4) that further facilitates the relative positioning between the tool 22 and the tool storage 24.

When the tool 22 is held by the tool storage 24, the connection part storage surface 48 of the tool 22 mates with one of the tool storage holding surfaces 64 of the tool storage 24. The connection part storage surface 48 is wider than the tool storage holding surface 64, i.e. the connection part storage surface 48 is wider than the thickness of the body 68.

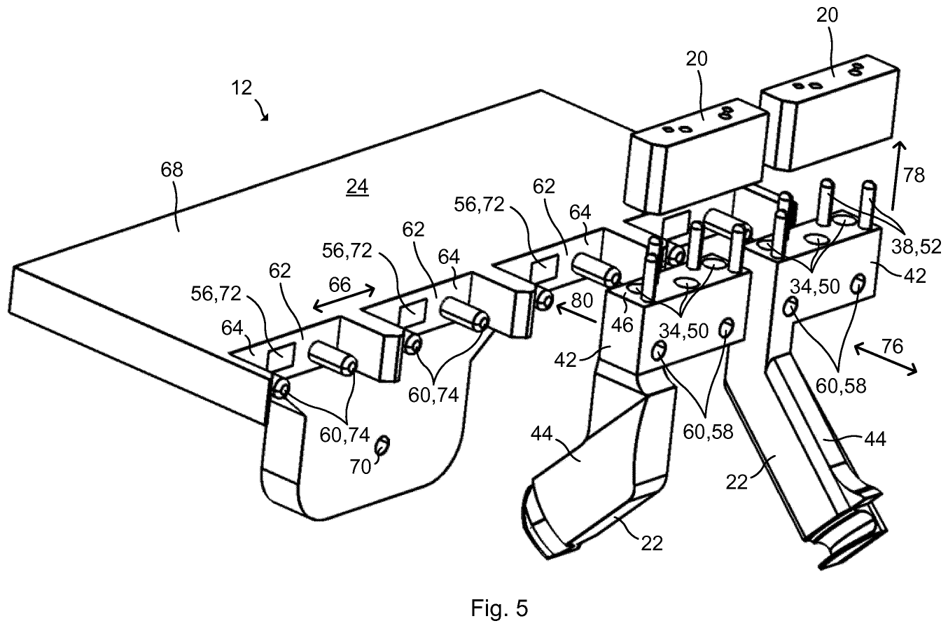

FIG. 5 schematically represents a perspective view of the tool changing system 12. FIG. 5 shows an actuation line 76 along which a base member 20 can move relative to an associated hand 26, e.g. during a gripping movement. FIG. 5 further shows that the left tool 22 can be attached to the tool storage 24 such that the gripper finger 44 protrudes below the body 68 of the tool storage 24.

FIG. 5 further shows a base member direction 78 along which the base member force device 34 forces the tool 22 to the base member 20 when the tool is held by the base member 20. In the example in FIG. 5, the base member direction 78 is perpendicular to the actuation line 76.

FIG. 5 further shows a tool storage direction 80 along which the tool storage force device 56 forces the tool 22 to the tool storage 24 when the tool 22 is held by the tool storage 24. As shown in FIG. 5, the tool storage direction 80 is perpendicular to the base member direction 78. In the example in FIG. 5, the tool storage direction 80 is parallel with the actuation line 76.

With reference to FIG. 5, one example of a method of handling tools 22 by the industrial robot 10 will be described. In order to detach a tool 22 held by a base member 20, the manipulator 14 is moved such that the base member 20 moves towards one of the storage positions 62 substantially in the tool storage direction 80, and such that the positioning openings 58 of the tool 22 are substantially aligned with the respective positioning pins 74 of the tool storage 24. During the last part of the movement in the tool storage direction 80, the tool storage positioning arrangement 60 will align the tool 22 relative to the tool storage 24 and the tool storage force device 56 will force the tool 22 to the selected storage position 62. The tool 22 is thereby held by the tool storage 24.

The manipulator 14 is then moved such that the base member 20 moves away from the tool 22 in the storage position 62 substantially in the base member direction 78, perpendicular to the tool storage direction 80. The tool 22 is thereby released from the base member 20 while the tool 22 is maintained held by the tool storage 24. The hand 26 may then be rotated to detach a second tool 22 from a second base member 20 in a second storage position 62 in the same way.

In order to attach a different tool 22 to the base member 20, the manipulator 14 is moved proximate to the storage position 62 of this tool 22. The manipulator 14 is then moved such that the base member 20 moves towards the tool 22 in the storage position 62 substantially parallel with the base member direction 78, and such that the positioning openings 36 of the base member 20 are substantially aligned with the respective positioning pins 52 of the tool 22. During the last part of the movement parallel with the base member direction 78, the base member positioning arrangement 38 will align the base member 20 relative to the tool 22 and the base member force device 34 will force the tool 22 to the base member 20. The tool 22 is thereby held by the base member 20.

The manipulator 14 is then moved such that the base member 20 moves away from the tool storage 24 substantially parallel with the tool storage direction 80. The tool 22 is thereby released from the tool storage 24 while the tool 22 is maintained held by the base member 20. The hand 26 may then be rotated to attach a second tool 22 to a second base member 20.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A tool changing system for an industrial robot, the tool changing system comprising:
a tool;
a base member for arrangement in a manipulator of the industrial robot and for holding the tool; and
a tool storage for holding the tool when released from the base member; and
a base member force device configured to force the tool to the base member in any orientation of the base member when the tool is held by the base member; and
a tool storage force device configured to force the tool to the tool storage in any orientation of the tool storage when the tool is held by the tool storage.

2. The tool changing system according to claim 1, wherein the base member force device includes a permanent magnet.

3. The tool changing system according to claim 1, wherein the tool storage force device includes a magnet.

4. The tool changing system according to claim 1, further comprising a manipulator having a distal link member, wherein the base member is arranged in the manipulator, and wherein the base member is configured to move linearly along an actuation line relative to the distal link member.

5. The tool changing system according to claim 4, wherein the base member force device is configured to force the tool to the base member in a base member direction substantially perpendicular to the actuation line when the tool is held by the base member.

6. The tool changing system according to claim 4, wherein the tool storage force device is configured to force the tool to the tool storage in a tool storage direction substantially parallel to the actuation line when the tool is held by the tool storage and by the base member.

7. The tool changing system according to claim 5, wherein the tool storage comprises a plurality of storage positions arranged along a storage position line, and wherein the storage position line is substantially perpendicular to each of the base member direction and the tool storage direction when the tool is held by the base member and by the tool storage.

8. The tool changing system according to claim 1, wherein the tool comprises a connection part having a connection part base surface, wherein the base member includes a base member holding surface, and wherein the base member force device is configured to force the connection part base surface matingly against the base member holding surface when the tool is held by the base member.

9. The tool changing system according to claim 1, wherein the tool comprises a connection part having a connection part storage surface, wherein the tool storage includes a tool storage holding surface, wherein the tool storage force device is configured to force the connection part storage surface matingly against the tool storage holding surface when the tool is held by the tool storage, and wherein the connection part storage surface is wider than the tool storage holding surface.

10. The tool changing system according to claim 1, further comprising a base member positioning arrangement configured to unambiguously define a relative position between the tool and the base member when the tool is held by the base member.

11. The tool changing system according to claim 1, further comprising a tool storage positioning arrangement configured to unambiguously define a relative position between the tool and the tool storage when the tool is held by the tool storage.

12. The tool changing system according to claim 1, wherein the tool storage comprises a flat body having a main extension plane, wherein the body includes a tool storage holding surface substantially perpendicular to the main extension plane of the body, and wherein the tool includes a connection part having a connection part storage surface for mating with the tool storage holding surface when the tool is held by the tool storage.

13. The tool changing system according to claim 1, wherein the tool comprises a connection part and a gripper finger for manipulating a workpiece, wherein the gripper finger extends from the connection part is configured to force the connection part against the base member when the tool is held by the base member, and wherein the tool storage force device is configured to force the connection part against the tool storage when the tool is held by the tool storage.

14. An industrial robot comprising a tool changing system the industrial robot including:
a tool;
a base member for arrangement in a manipulator of the industrial robot and for holding the tool; and
a tool storage for holding the tool when released from the base member; and
a base member force device configured to force the tool to the base member in any orientation of the base member when the tool is held by the base member; and
a tool storage force device configured to force the tool to the tool storage in any orientation of the tool storage when the tool is held by the tool storage.

15. A method of handling a tool by an industrial robot, the industrial robot including a manipulator having a base member for holding a tool, a tool storage for holding the tool when released from the base member, a base member force device configured to force the tool to the base member in any orientation of the base member when the tool is held by the base member, and a tool storage force device configured to force the tool to the tool storage in any orientation of the tool storage when the tool is held by the tool storage, the method comprising:
holding the tool to the base member by means of the base member force device;
moving the tool to the tool storage by means of the manipulator such that the tool is additionally held by the tool storage by means of the tool storage force device, and such that the base member force device exerts a force on the tool in a base member direction and the tool storage force device exerts a force on the tool in a tool storage direction substantially perpendicular to the base member direction, and
moving the base member by means of the manipulator substantially perpendicular to the tool storage direction such that the tool is released from the base member and maintained held by the tool storage.

16. The tool changing system according to claim 2, wherein the tool storage force device includes a magnet.

17. The tool changing system according to claim 2, further comprising a manipulator having a distal link member, wherein the base member is arranged in the manipulator, and wherein the base member is configured to move linearly along an actuation line relative to the distal link member.

18. The tool changing system according to claim 5, wherein the tool storage force device is configured to force the tool to the tool storage in a tool storage direction substantially parallel to the actuation line when the tool is held by the tool storage and by the base member.

19. The tool changing system according to claim 6, wherein the tool storage comprises a plurality of storage positions arranged along a storage position line, and wherein the storage position line is substantially perpendicular to each of the base member direction and the tool storage direction when the tool is held by the base member and by the tool storage.
